(19) United States
(12) Patent Application Publication
(10) Pub. No.: US 2010/0207757 A1
(43) Pub. Date: Aug. 19, 2010

(54) SYSTEM AND METHOD FOR ADJUSTING THE RESOLUTION OF AN INFORMATION DISPLAY FOR A VEHICLE

(75) Inventors: Ivette Hernandez, Westland, MI (US); Angela L. Watson, Ann Arbor, MI (US); David Watson, Ann Arbor, MI (US); Sohel Merchant, Canton, MI (US); Craig Sandvig, Sterling Heights, MI (US); Steven Bishop, Mountain View, CA (US); Altay Jun Wakui Sendil, Pacifica, CA (US); Engin Erdogan, San Francisco, CA (US); Susanne Stage, San Francisco, CA (US)

Correspondence Address: BROOKS KUSHMAN P.C./FGTL, 1000 TOWN CENTER, 22ND FLOOR, SOUTHFIELD, MI, 48075-1238, US

(73) Assignee: Ford Global Technologies, LLC, Dearborn, MI (US)

(21) Appl. No.: 12/371,714

(22) Filed: Feb. 16, 2009

(51) Int. Cl. G09F 9/00

(52) U.S. Cl. 340/461

(57) ABSTRACT

A system and method for adjusting the resolution setting of an operating condition of a vehicle displayed using an information display system. The information display system comprising an information display that includes at least one gauge configured to display information indicative of a vehicle operating parameter. A controller may receive information indicative of the vehicle operating condition to be displayed on the at least one gauge. The controller may allow adjustment to the resolution setting of the at least one gauge. Also, the controller may transmit the resolution setting and the vehicle operating parameter so that the at least one gauge displays the vehicle operating condition using the resolution setting.

### BACKGROUND

1. Technical Field

One or more embodiments of the present application relate to a system and method for adjusting the resolution of an information display within a vehicle.

2. Background Art

Vehicles, whether passenger or commercial, include a number of gauges, indicators, and various other displays to provide the vehicle operator with information regarding the vehicle and its surroundings. With the advent of new technologies, such as hybrid electric vehicles (HEVs), has come a variety of new gauges and information displays that help operators to better learn the operation of these vehicles that utilize new technology. For example, many HEVs incorporate gauges that attempt to provide the operator with information on the various hybrid driving states. These gauges indicate to the operator when the vehicle is being propelled by the engine alone, the motor alone, or a combination of the two. Similarly, a display may indicate when the motor is operating as a generator, and is recharging an energy storage device, such as a battery.

With regard to HEVs, it is known that sophisticated operators knowledgeable about the operation of the vehicle may require that a high level of detail be displayed to them upon an information display. By displaying a greater level of detail, an experienced operator may be capable of using the data displayed in order to optimize the performance of the vehicle. Conversely, operators who are not as sophisticated as to the operation of HEVs, or the data presented on the information display, may prefer that only a low, or minimal, level of detail be displayed. By displaying a more minimalistic level of detail, the non-sophisticated driver may be presented only with enough detail as required to operate the vehicle. Therefore, a need exists for an information display for a vehicle that allows for adjustment as to the overall level of data resolution displayed to the operator.

### BRIEF DESCRIPTION OF THE DRAWINGS

FIG. 1 illustrates a schematic representation of a hybrid electric vehicle including an information display system in accordance with one or more embodiments of the present application;

FIG. 2a shows in detail the information display system depicted in FIG. 1 in accordance with one or more embodiments of the present application;

FIG. 2b shows an alternate view of the information display system depicted in FIG. 2a;

FIG. 2c shows another alternate view of information display system depicted in FIG. 2a; and

FIG. 3a shows in detail the information display system depicted in FIG. 1 in accordance with one or more embodiments of the present application;

FIG. 3b shows an alternate view of the information display system depicted in FIG. 3a;

FIG. 3c shows another alternate view of information display system depicted in FIG. 3a; and

FIG. 4 is a simplified, exemplary flow chart depicting one or more embodiments of the present application described herein.

### DETAILED DESCRIPTION

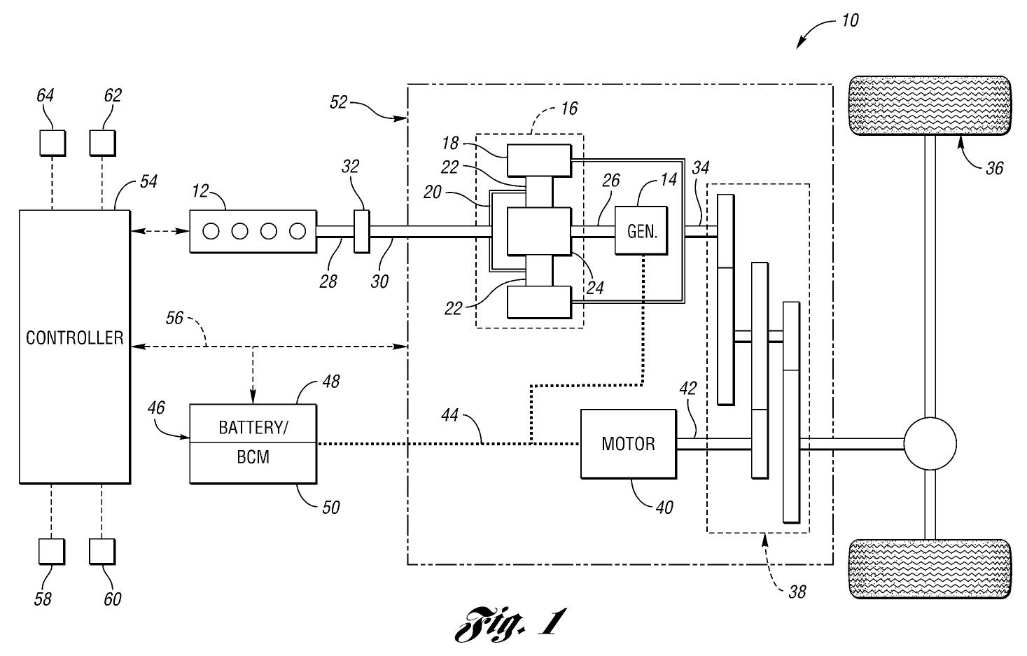

FIG. 1 shows a schematic representation of a vehicle 10, which includes an engine 12 and an electric machine, or a generator 14. The engine 12 and the generator 14 are connected through a power transfer arrangement, which in this embodiment, is a planetary gear arrangement 16. Of course, other types of power transfer arrangements, including other gear sets and transmissions, may be used to connect the engine 12 to the generator 14. The planetary gear arrangement 16 includes a ring gear 18, a carrier 20, planet gears 22, and a sun gear 24.

The generator 14 can also output torque to a shaft 26 connected to the sun gear 24. Similarly, the engine 12 outputs torque to a crankshaft 28, which is connected to a shaft 30 through a passive clutch 32. The clutch 32 provides protection against over-torque conditions. The shaft 30 is connected to the carrier 20 of the planetary gear arrangement 16, and the ring gear 18 is connected to a shaft 34, which is connected to a first set of vehicle drive wheels, or primary drive wheels 36, through a gear set 38.

The vehicle 10 includes a second electric machine, or motor 40, which can be used to output torque to a shaft 42 connected to the gear set 38. Other vehicles within the scope of the one or more embodiments of the present application may have different electric machine arrangements, such as more or fewer than two electric machines. In the embodiment shown in FIG. 1, the electric machine arrangement (i.e. the motor 40 and the generator 14) can both be used as motors to output torque. Alternatively, each can also be used as a generator, outputting electrical power to a high voltage bus 44 and to an energy storage system 46, which includes a battery 48 and a battery control module (BCM) 50.

The battery 48 is a high voltage battery that is capable of outputting electrical power to operate the motor 40 and the generator 14. The BCM 50 acts as a controller for the battery 48. Other types of energy storage systems can be used with a vehicle, such as the vehicle 10. For example, a device such as a capacitor can be used, which, like a high voltage battery, is capable of both storing and outputting electrical energy. Alternatively, a device such as a fuel cell may be used in conjunction with a battery and/or capacitor to provide electrical power for the vehicle 10.

As shown in FIG. 1, the motor 40, the generator 14, the planetary gear arrangement 16, and a portion of the second gear set 38 may generally be referred to as a transmission 52. To control the engine 12 and components of the transmission 52 (i.e., the generator 14 and motor 40) a vehicle control system, shown generally as controller 54, is provided. Although it is shown as a single controller, it may include multiple controllers which may be used to control multiple vehicle systems. For example, the controller 54 may be a vehicle system controller/powertrain control module (VSC/PCM).

A controller area network (CAN) 56 allows the controller to communicate with the transmission 52 and the BCM 50. Just as the battery 48 includes a BCM 50, other devices may have their own controllers. For example, an engine control unit (ECU) may communicate with the controller 54 and may perform control functions on the engine 12. In addition, the transmission 52 may include a transmission control module (TCM), configured to coordinate control of specific components within the transmission 52, such as the generator 14 and/or the motor 40. Some or all of these various controllers can make up a control system in accordance with the present application. Although illustrated and described in the context of the vehicle 10, which is an HEV, it is understood that embodiments of the present application may be implemented on other types of vehicles, such as those powered by an engine or electronic motor alone.

Also shown in FIG. 1 are simplified schematic representations of a braking system 58, an accelerator pedal 60, and an air conditioning system 62. The braking system 58 may include such things as a brake pedal, position sensors, pressure sensors, or some combination of the two, as well as a mechanical connection to the vehicle wheels, such as the wheels 36, to effect friction braking. The braking system 58 may also include a regenerative braking system, wherein braking energy is captured and stored as electrical energy in the battery 48. Similarly, the accelerator pedal 60 may include one or more sensors, which, like the sensors in the braking system 58, communicate with the controller 54.

The air conditioning system 62 also communicates with the controller 54. The on/off status of the air conditioning system can be communicated to the controller 54, and can be based on, for example, the status of an operator actuated switch, or the automatic control of the air conditioning system 62 based on related functions such as window defrost. In addition to the foregoing, the vehicle 10 may include an information display system 64 that is used to display one or more vehicle operating conditions. The information display system 64 may, as explained in more detail below, allow for adjustment as to the resolution setting of the vehicle operating conditions.

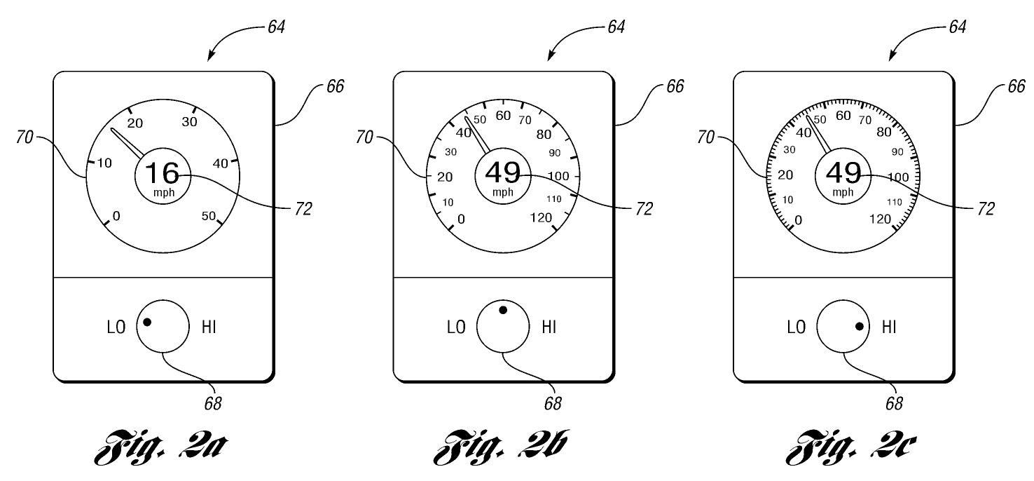

FIGS. 2a-2c refer generally to the information display system 64 according to one or more embodiments of the present application. The information display system 64 may include an information display 66 and electronics including software which are not shown in FIGS. 2a-2c. The information display 66 may display the vehicle operating conditions using a liquid crystal display (LCD), a plasma display, an organic light emitting display (OLED), or any other display suitable to display the vehicle operating conditions.

The information display system 64 may also include a control mechanism 68 that provides an operator the ability to adjust the resolution setting of the information display 66. The control mechanism 68 may allow the resolution setting of the information display to be adjusted through the use of a knob (as shown in FIGS. 2a-2c) scroll wheel, a touch screen, a push button, or any other control mechanism 68 suitable for adjusting the resolution setting of the information display 66.

It is generally contemplated that the control mechanism 68 may be a voice recognition system (not shown) that allows audible adjustment of the resolution setting. For example, one or more embodiments of the present application contemplate that the voice recognition system may be the Ford Sync™ system currently implemented on many Ford Motor Company™ vehicles. As such, the voice recognition system may include a series of audible commands that provides the operator the capability of adjusting the resolution setting displayed on the information display 66.

The information display system 64 may further include memory (not shown), such as electrically erasable and programmable read-only memory (EPROM), which may be used to store a plurality of default resolution settings. The controller 54 may be further configured to recall from the memory the default resolution settings. Thereafter, the controller may transmit the default resolution settings to the information display 66 so that the vehicle operating conditions are displayed on the information display 66 using the default operating settings.

Alternatively, the memory may be used by an operator to store adjusted resolution settings using one or more operator parameters. The operator may use the control mechanism 68 to adjust the resolution setting of the vehicle operating conditions and to indicate to the controller 54 that the adjusted resolution setting should be stored on the memory as one of the operator parameters. Subsequently, the operator may use the control mechanism 68 to select the operator parameter stored on the memory and the controller 54 may recall the operator parameter from the memory. Once recalled, the controller 54 may transmit the operator parameter to the information display 66 so that the vehicle operating condition is displayed on the information display 66 using the operator parameter.

For example, the information display system 64 may initially be configured so that the information display 66 illustrated in FIG. 2a is the default resolution setting used to display a current vehicle speed. However, if a greater level of detail is desired, then the resolution setting of the information display 64 may be adjusted in order to increase the overall detail displayed. Once the resolution setting of the data displayed has been adjusted, the operator may indicate to the controller 54 that the adjusted resolution setting should be stored in the memory as one of the operator parameters. Furthermore, the operator may use the control mechanism 68 to indicate to the controller 54 that the operator parameter should be recalled from the memory. Once recalled, the controller 54 may transmit the operator parameter to the information display 66 so that the current average vehicle speed is displayed on the information display 66 using the operator parameter.

Although the information display 66 depicted in FIGS. 2a-2c illustrate a speedometer, it is fully contemplated herein that data resolution adjustment may be provided for other display gauges without departing from the scope of the present application. Other non-limiting examples in which data resolution settings may be adjusted may include speedometers, tachometers, engine coolant temperature gauges, fuel economy gauges, fuel level gauges, accessory load gauges, or the like.

One or more embodiments of the present application further contemplates that the information display system 64 may be configured so that the resolution setting may be adjusted automatically using a vehicle operating parameter (e.g., vehicle speed or fuel). The controller 54 may receive information indicative of an adjustment threshold and may determine whether the vehicle operating condition has exceeded the adjustment threshold. If the controller 54 determines that the vehicle operating parameter has exceeded the adjustment threshold, then the controller may determine an adjusted resolution setting. The controller 54 may then transmit the adjusted resolution setting so that the information display 66 displays the vehicle operating condition suing the automatically determined adjusted resolution setting.

For example, the information display system 64 may be configured so that the information display 66, as illustrated in FIG. 2a, may be displayed when the vehicle 10 is started. As the vehicle 10 begins to accelerate, the resolution setting may automatically adjust so that the information display 66 displayed may be similar to FIG. 2b. Furthermore, as the vehicle 10 accelerates even further, the resolution setting may again automatically adjust so that the information display 66 displayed may be similar to FIG. 2c.

The information display system 64 may further be configured to allow replacing the default resolution setting with one of the stored operator parameters. As such, each time the vehicle 10 is operated, the controller 54 will recall from the memory the operator parameter in place of the default resolution setting. Once recalled, the controller 54 may transmit the operator parameter to the information display 66 so that the vehicle operating conditions are displayed on the information display 66 using the operator parameter.

In addition to the foregoing, the information display system 66 may be further configured so that the controller 54 may store on the memory multiple adjusted resolution settings indicative of multiple vehicle operating conditions as one of the operator parameters. For example, if the resolution settings of an engine coolant temperature gauge, speedometer, and fuel efficiency gauges were modified, the operator may use the control mechanism 68 to indicate to the controller 54 that such changes should be stored on the memory as one of the operator parameters. Thereafter, the operator may be able to use the control mechanism 68 to indicate to the controller 54 that the operator parameter should be recalled from the memory. The controller 54 may recall the operator parameter from the memory and may transmit the operator parameter to the information display 66 so that the plurality of vehicle operating conditions are displayed on the information display 66 using the operator parameter.

With reference back to FIG. 2a, the resolution setting of the information display 66 may be adjusted so that the vehicle operating conditions may be displayed using a low level of detail. The information display 66 may use the low level of detail in order to visually indicate large fluctuations in the vehicle operating conditions. Thus, when the resolution of the information display 66 is adjusted to a low level of detail, minor fluctuations to the operating conditions of the vehicle 10 may be less discernable to the operator.

For example, the resolution setting may be adjusted so that the information display 66 displays one or more tick marks 70 indicative of the speed of the vehicle 10. As is illustrated in FIG. 2a, the resolution setting of the tick marks 70 may be adjusted to increment of ten M.P.H. Using the resolution setting of FIG. 2a, the operator may only be able to determine an approximate speed of the vehicle 10. As such, when the vehicle 10 is operated at a speed of twenty-five M.P.H, the operator may not be able to determine the exact speed of the vehicle. However, the operator may be able to discern that the vehicle 10 is being operated within the speed range of twenty to thirty M.P.H.

Alternatively, if the resolution of the information display 66 is adjusted to a low level of detail, minor fluctuations in the vehicle operating conditions may not be displayed to the operator of the vehicle 10. As such, the low resolution setting may display the vehicle operating parameters on the information display 66 as a numerical value 72, as is shown in FIG. 2a. Alternatively, when a low resolution setting is desired, the vehicle operating condition may be displayed on the information display 66 using a visual indicator (not shown). For example, an engine coolant temperature may be displayed on the information display 66 using a “high” or “low” indicator light. When the engine coolant temperature is above or below a safe operating threshold, the information display 66 may display the “high” or “low” indicator light, respectively. Thus, the “high” or “low” indicator light may be used to visually alert the operator when the engine coolant temperature of the vehicle 10 exceeds a safe engine temperature operating threshold.

Contrastingly, the resolution setting of the information display 66 may be adjusted so that the vehicle operating condition may be displayed using a moderate level of detail, as shown in FIG. 2b. The level of detail desired by the operator may be higher than the resolution setting described above with reference to FIG. 2a. As such, the resolution setting may be adjusted so that more minor fluctuations in regards to the corresponding vehicle operating condition may be displayed. The operator may use the fluctuations displayed to modify operation of the vehicle 10 in order to increase the overall efficiency of the vehicle 10.

For example, an operator knowledgeable about the operation of the vehicle 10 may require a greater amount of detail regarding an amount of battery charge available. In order to display the desired level of detail, the information display 66 may be adjusted to a more detailed resolution setting. By adjusting the information display 64, the operator may be more visually informed when the battery is within a useable range or when the battery is being charged or discharged. In turn, the operator may be able to modify the operation of the vehicle 10 so that the battery is operated within the useable range. By modifying the operation of the vehicle 10 so that the battery is operated within the useable range, the operator may increase the overall efficiency of the vehicle 10.

The resolution setting of the information display 66 may also be adjusted so that the vehicle operating condition may be displayed using a high level of detail, as shown by way of example in FIG. 2c. The level of detail desired by the operator may be higher than the resolution settings described above with reference to FIGS. 2a and 2b.

The information display 66 may be adjusted to the high resolution setting so that minor fluctuations in regards to the corresponding vehicle operating conditions are visible. The operator may desire minor fluctuations displayed in regards to the vehicle operating conditions, for example, during diagnostic applications or during servicing of the vehicle 10. For example, if the engine coolant temperature continually exceeded a normal engine coolant temperature threshold, a technician may increase the data resolution of the display in order to diagnose the cause. By examining the more minute fluctuations, the technician may be capable of assessing why the engine coolant temperature is exceeding the normal vehicle temperature threshold.

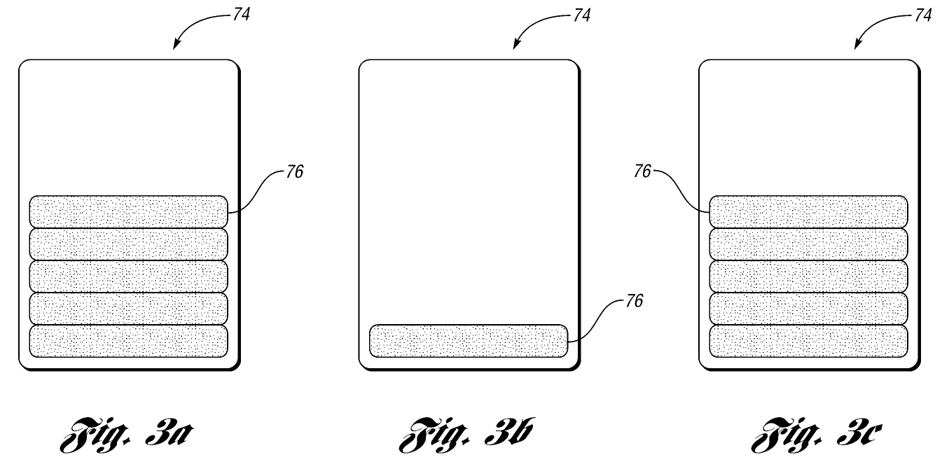

Alternatively, one or more embodiments of the present application contemplate that the high level of detail may be desired in order to further increase the resolution setting of a particular vehicle operating parameter. For example, FIG. 3a illustrates a fuel level gauge 74 that may visually indicate an amount of fuel (e.g. gallons) using one or more bar segments 76. As is further illustrated in FIG. 3a, the bar segments 76 may be initially adjusted so that the resolution setting of each bar segment 76 may be equal to one gallon of fuel. With reference to FIG. 3b, as the vehicle 10 is driven the number of bar segments 76 may decrease in accordance with the amount of fuel remaining in the vehicle 10. However, when only one bar segment 76 remains, as illustrated in 3b, the operator may wish to again adjust the resolution setting in order to further increase the level of detail of the remaining bar segment 76. Therefore, the resolution setting may again be adjusted, as illustrated in FIG. 3c, so that the level of detail is adjusted and each bar segment 76 may be equal to approximately one-tenth of one gallon of fuel. As such, the adjusted bar segments 76 illustrated in FIG. 3c, may visually indicate precisely how much fuel remains with respect to the last gallon of fuel.

Although FIGS. 2a-2b collectively illustrates three different resolution levels, more or less than three resolution levels may be provided without departing from the scope of the present application.

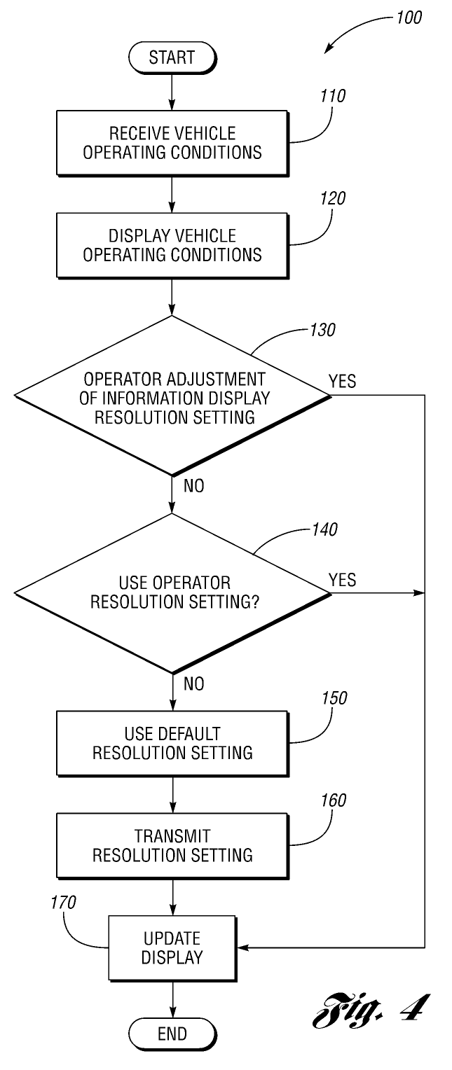

With reference back to the drawings, FIG. 4 illustrates a simplified, exemplary flow diagram 100 demonstrating how the resolution setting of the information display 66 may be adjusted. In particular, at step 110, one or more sensed or non-sensed inputs that correspond to current vehicle operating conditions may be received by the controller 54. The received vehicle operating conditions may be used by the controller 54, for example, in order to determine the speed of the vehicle 10, the amount of fuel remaining in the vehicle 10, the amount of oil remaining in the vehicle 10, the temperature of the engine of the vehicle 10, the amount of energy remaining within a battery of the vehicle 10, or the engine cycle displayed in revolutions per minute (RPM) of the vehicle 10. Once the sensed and non-sensed vehicle operating conditions are received by the controller 54, the flow diagram 100 may proceed to step 120 wherein at least one vehicle operating condition is displayed by information display 66.

In step 130, the controller 54 may determine if the operator has adjusted the resolution setting to be displayed on the information display 66. If so, the controller 54 may determine that the adjusted resolution setting should be displayed on the information display 66 and the flow diagram 100 may proceed to step 160. However, if the operator has not adjusted the resolution setting to be displayed on the information display 66, then the flow diagram 100 may proceed to step 140.

In step 140, the controller 54 may determine whether to display the operator resolution settings. If the information control system 64 has been programmed to use one of the operator resolution settings, then the controller 54 gathers the operator resolution setting desired and the flow diagram 100 proceeds to step 160. Alternatively, if the information control system 64 has not been instructed to use one of the operator information display settings, then the flow diagram proceeds to step 150. In step 150, the controller 54 determines which default resolution setting should be used and the flow diagram 100 proceeds to step 160.

In step 160, the controller 54 may transmit the resolution setting selected so that the information display 66 displays the vehicle operating condition based upon the resolution setting received. The information display 66 may then be updated accordingly at step 170. For example, if one of the operator resolution settings has been selected, then the controller 54 will transmit the corresponding resolution settings and the information display 66 will display the vehicle operating conditions using the selected operator resolution setting.

It should be noted that the method of FIG. 4 as described herein is exemplary only in that the functions are steps of the methods can be undertaken other than described and/or simultaneously as may be desired, permitted and/or possible.

While the best mode for carrying out the invention has been described in detail, those familiar with the art to which this invention relates will recognize various alternative designs and embodiments for practicing the present invention as defined by the following claims.

What is claimed:

1. An information display system for a vehicle, the information display system comprising:
an information display including at least one gauge, wherein the at least one gauge is configured to display information indicative of a vehicle operating condition; and
a controller being configured to:
receive information indicative of the vehicle operating condition to be displayed on the at least one gauge;
receive information indicative of an adjustment to the resolution setting of the at least one gauge; and
transmit the information indicative of the vehicle operating condition and the resolution setting so that the at least one gauge displays the vehicle operating condition using the resolution setting.

2. The information display system of claim 1, wherein the controller is further configured to receive audible information, and the controller further being configured to allow adjustment to the resolution setting of the information display using the audible information.

3. The information display system of claim 1, wherein the controller is further configured to:
receive information indicative of an adjustment threshold;
determine if the information indicative of the vehicle operating condition has exceeded the adjustment threshold;
automatically determine an adjusted resolution setting of the at least one gauge when the vehicle operating parameter exceeds the adjustment threshold; and
transmit the adjusted resolution setting so that the at least one gauge displays the vehicle operating condition using the adjusted resolution setting.

4. The information display system of claim 1, wherein the gauge is a speedometer that displays the speed of the vehicle based upon a speed interval setting, and the controller is further configured to transmit the resolution setting so that the speedometer displays the speed interval setting using the resolution setting.

5. The information display system of claim 1, wherein the gauge is a fuel economy gauge that displays the fuel economy of the vehicle based upon a fuel economy interval setting, and the controller is further configured to transmit the resolution setting so that the fuel economy gauge displays the fuel economy interval setting using the resolution setting.

6. The information display system of claim 1, wherein the gauge is an engine temperature gauge that displays the engine temperature of the vehicle based upon an engine temperature interval setting, and the controller is further configured to transmit the resolution setting so that the engine temperature gauge displays the engine temperature interval setting using the resolution setting.

7. The information display system of claim 1, wherein the information display system further includes a memory, and the controller further being configured to store on the memory the adjusted resolution setting as one of the operator parameters, the controller further being configured recall from the memory the operator parameters and the controller further being configured to transmit the operator parameter so that the information display displays the vehicle operating condition using the operator parameter.

8. The information display system of claim 7, wherein the controller is further configured to store on the memory a plurality of adjusted resolution settings as one of the operator parameters, the controller further being configured to recall from the memory the operator parameters, and the controller further being configured to transmit the operator parameter so that the information display displays the plurality of adjusted resolution settings using the operator parameter.

9. The information display system of claim 8, wherein the controller is further configured to store on the memory a plurality of default resolution settings, the controller further being configured recall from the memory the plurality of default resolution settings, and the controller further being configured to transmit the default resolution settings so that the information display displays the plurality of adjusted resolution settings using the default resolution settings.

10. The information display system of claim 1, wherein the vehicle includes an engine and an electric machine, each operable to provide torque to propel the vehicle, the vehicle further including an electric power source configured to provide electric power to the electric machine, wherein the one or more visual gauges contain vehicle content corresponding to the engine, the electric machine and the electric power source.

11. An information display system for a vehicle including an engine and an electric machine, each operable to provide torque to propel the vehicle, the vehicle further including an electric power source configured to provide electric power to the electric machine, the information display system comprising:
an information display including at least one gauge, wherein the at least one gauge is configured to display information indicative of a vehicle operating condition; and
a controller being configured to:
receive information indicative of the vehicle operating condition to be displayed on the information display;
receive information indicative of a lower resolution setting limit and an upper resolution setting limit;
receive information indicative of adjustment to the resolution setting of the at least one gauge within the lower resolution setting limit and the upper resolution setting limit; and
transmit the information indicative of the vehicle operating condition and the resolution setting so that the at least one gauge displays the vehicle operating condition using the resolution setting.

12. The information display system of claim 11, wherein the controller is further configured to receive audible information, and the controller further being configured to allow adjustment to the resolution setting of the information display using the audible information.

13. The information display system of claim 11, wherein the controller is further configured to:
receive information indicative of an adjustment threshold;
determine if the information indicative of the vehicle operating condition has exceeded the adjustment threshold;
automatically determine an adjusted resolution setting of the at least one gauge when the vehicle operating parameter exceeds the adjustment threshold; and
transmit the adjusted resolution setting so that the at least one gauge displays the vehicle operating condition using the adjusted resolution setting.

14. The information display system of claim 11, wherein the gauge is a speedometer that displays the speed of the vehicle based upon a speed interval setting, and the controller is further configured to transmit the resolution setting so that the speedometer displays the speed interval setting using the resolution setting.

15. The information display system of claim 11, wherein the gauge is a fuel economy gauge that displays the fuel economy of the vehicle based upon a fuel economy interval setting, and the controller is further configured to transmit the resolution setting so that the fuel economy gauge displays the fuel economy interval setting using the resolution setting.

16. The information display system of claim 11, wherein the gauge is an engine temperature gauge that displays the engine temperature of the vehicle based upon an engine temperature interval setting, and the controller is further configured to transmit the resolution setting so that the engine temperature gauge displays the engine temperature interval setting using the resolution setting.

17. The information display system of claim 11, wherein the information display system further includes a memory, and the controller further being configured to store on the memory the adjusted resolution setting as one of the operator parameters, the controller further being configured recall from the memory the operator parameters and the controller further being configured to transmit the operator parameter so that the information display displays the vehicle operating condition using the operator parameter.

18. The information display system of claim 17, wherein the controller is further configured to store on the memory a plurality of adjusted resolution settings as one of the operator parameters, the controller further being configured recall from the memory the operator parameters, and the controller further being configured to transmit the operator parameter so that the information display displays the plurality of adjusted resolution settings using the operator parameter.

19. A method for displaying an adjusted resolution setting of an operating condition of a vehicle using an information display, the information display including at least one gauge, the method comprising:
receiving information indicative of a vehicle operating condition to be displayed on the at least one gauge;
receiving information indicative of an adjustment to the resolution setting of the vehicle operating condition to be displayed on the at least one gauge; and
transmitting the information indicative of the vehicle operating condition and the resolution setting so that the information display displays the vehicle operating condition on the at least one gauge using the adjusted resolution setting.

20. The method of claim 19 further comprising:
receiving information indicative of an adjustment threshold;
determining if the information indicative of the vehicle operating condition has exceeded the adjustment threshold;
automatically determining an adjusted resolution setting of the at least one gauge when the vehicle operating parameter exceeds the adjustment threshold; and
transmitting the adjusted resolution setting so that the at least one gauge displays the vehicle operating condition using the adjusted resolution setting.
